(19) United States
(12) Patent Application Publication
(10) Pub. No.: US 2026/0288985 A1
(43) Pub. Date: Sep. 24, 2026

(54) SYSTEM AND METHOD FOR PRIVACY-PRESERVING PRINTER SOURCE IDENTIFICATION OF QR CODE LABELS

(71) Applicant: Lingnan University, Hong Kong (HK)

(72) Inventors: Sam Tak Wu KWONG, Hong Kong (HK); Zhongyuan GUO, Hong Kong (HK)

(21) Appl. No.: 19/088,928

(22) Filed: Mar. 24, 2025

(51) Int. Cl. G06F 21/60; G06K 7/14

(52) U.S. Cl. CPC G06F 21/608; G06K 7/1417

(57) ABSTRACT

In the present invention, federated learning provides a solution by enabling models to be trained using locally distributed data across multiple clients, reducing reliance on a centralized server. Each client, such as each smartphone in a smartphone group, independently trains a local model using its dataset and shares only model parameters with other participants, without transmitting actual QR code image data. The decentralized learning approach enhances data security and privacy, as sensitive information remains on-device, mitigating risks associated with data leakage and unauthorized access. Furthermore, by leveraging cyclic weight transfer, the system allows smartphones to sequentially update model weights, contributing to a continuously improving global model while preserving user privacy.

### TECHNICAL FIELD

The present invention relates to a system and method for privacy-preserving printer source identification of QR code labels, particularly for identifying QR code labels using smartphone.

### BACKGROUND

In the field of anti-counterfeiting products, QR code labels are widely printed on the packaging of various products as anti-counterfeiting labels. Consumers can verify the authenticity of products by scanning QR codes with their smartphones. However, the QR code itself does not have an anti-counterfeiting function and is easily counterfeited by illegal copying, which is achieved mainly by scanning and reprinting genuine QR code labels. Forged QR codes are bundled with counterfeit and substandard products and enter the market, posing risks to consumers' physical and mental health, damaging merchants' credibility, and even disrupting market order.

QR code labels inherently carry the unique characteristics of the printer used in their production, often referred to as the printer's fingerprint. Since authorized printers that produce genuine QR codes are difficult for counterfeiters to access, counterfeiting is primarily carried out using unauthorized printers. As a result, the use of image processing and deep learning technology for QR code printer source identification has gained increasing attention and has become a significant research focus.

Identifying the printer source of QR code labels through smartphones offers a convenient, fast, and effective approach. However, when QR code label images are captured using mobile devices, the identification accuracy of deep learning models is often degraded due to factors such as interference, noise, and blurring during image acquisition. Furthermore, in previous printer source identification tasks, QR code data was collected, stored, and processed in a centralized manner. However, increasingly stringent privacy-protection regulations and growing concerns over data privacy have introduced new challenges to traditional centralized training models. Consumers are often unwilling to upload or share locally captured QR code data due to privacy concerns, making centralized data collection, storage, and processing unsustainable.

Therefore, there is a pressing need to explore solutions that balance privacy protection with practical authentication requirements.

### SUMMARY OF INVENTION

It is an objective of the present invention to provide systems and methods to address the aforementioned shortcomings and unmet needs in the state of the art.

Verification of QR code anti-counterfeiting labels using smartphones has become mainstream, but it is susceptible to threats from illegal copying and printing, making printer source identification an effective means of authenticity verification. Deep learning techniques play a significant role in QR code label printer source identification; however, existing deep models rely on centralized data collection and training approaches, posing risks of privacy leakage.

To address this issue, the present invention provides a system and method for privacy-preserving printer source identification of QR code labels using Serial Federated Learning and a Pretrained Vision Transformer (SFed-PFormer). The system utilizes a Vision Transformer model pre-trained on a large-scale dataset, which is fine-tuned for QR code printer source identification through an effective parameter migration strategy. The model is then deployed within a decentralized serial federated learning framework, where weight parameters are cyclically transferred and updated across different smartphones, enabling data fusion and balancing without compromising user privacy.

This approach mitigates overfitting and significantly enhances robustness. In the present disclosure, experimental evaluations on a self-built QR code dataset, consisting of QR codes captured by five smartphones and produced by nine printers, confirm the effectiveness of the proposed solution in achieving accurate and privacy-preserving printer source identification.

In accordance with a first aspect of the present invention, a system for printer source identification through classifying QR codes is provided. The system includes at least one data collection module, at least one data preprocessing module, a pre-trained model storage and retrieval module, a fine-tuning module, a QR code source identification module, a decentralized learning module, and a verification and output module. The data collection module is configured to acquire QR code images from different printers which comprise both legitimate and counterfeit devices to construct a QR code dataset. The data preprocessing module communicates with the data collection module and is configured to extract QR code regions from the QR code images of the QR code dataset, convert the extracted QR code regions into fixed-size patches, and apply position embeddings to format the patches for transformer-based analysis. The pre-trained model storage and retrieval module is configured to store a vision transformer (ViT) model pre-trained on a large-scale dataset and to retrieve the pre-trained ViT model when required for QR code printer source identification. The fine-tuning module communicates with the data preprocessing module and the pre-trained model storage and retrieval module and is configured to adapt the pre-trained ViT model to the QR code printer source identification by optimizing the pre-trained ViT model for printer-specific feature extraction and classification. The QR code source identification module is configured to classify QR codes based on their source printers by utilizing the fine-tuned ViT model and to generate corresponding classification results. The decentralized learning module is configured to facilitate local updates of the VIT model on smartphones performing the QR code printer source identification, in which only model parameters are transmitted to prevent raw data transmission to a central server. The cyclic weight transfer module is configured to sequentially transmit updated model weights of the ViT model across the smartphones, allowing each of the smartphones to preserve user privacy and avoid centralized raw data aggregation. The verification and output module communicates with the QR code source identification module and is configured to determine whether one or more given QR codes originate from an authorized printer and to output one or more verification results indicating authenticity or counterfeit status.

In accordance with a second aspect of the present invention, a method for printer source identification through classifying QR codes is provided. The method includes steps as follows: acquiring, by at least one data collection module, QR code images from different printers which comprise both legitimate and counterfeit devices to construct a QR code dataset; extracting, by at least one data preprocessing module, QR code regions from the QR code images of the QR code dataset; converting, by the data preprocessing module, the extracted QR code regions into fixed-size patches; applying, by the data preprocessing module, position embeddings to format the patches for transformer-based analysis; storing, by a pre-trained model storage and retrieval module, a vision transformer (ViT) model pre-trained on a large-scale dataset; retrieving, by the pre-trained model storage and retrieval module, the pre-trained ViT model when required for QR code printer source identification; adapting, by a fine-tuning module, the pre-trained ViT model to the QR code printer source identification by optimizing the pre-trained ViT model for printer-specific feature extraction and classification; classifying QR codes, by QR code source identification module, based on their source printers by utilizing the fine-tuned ViT model and thus generating corresponding classification results; facilitating, by a decentralized learning module, local updates of the ViT model on smartphones performing the QR code printer source identification, wherein only model parameters are transmitted to prevent raw data transmission to a central server; sequentially transmitting, by a cyclic weight transfer module, updated model weights of the ViT model across the smartphones, thereby allowing each of the smartphones to preserve user privacy and avoid centralized raw data aggregation; and determining, by a verification and output module, whether one or more given QR codes originate from an authorized printer and thus outputting one or more verification results for indicating authenticity or counterfeit status.

Based on the above configuration, the present invention proposes a privacy-preserving printer source identification method for QR code labels using Serial Federated Learning and Vision Transformer. The present invention provides a novel solution that integrates Vision Transformer and Federated Learning for printer source identification, offering a privacy-preserving and decentralized approach to QR code authentication.

The contributions of the present invention are summarized as follows:
(1) A serial federated learning framework using a pre-trained Vision Transformer model (SFed-PFormer) is provided, which effectively protects user data privacy while maintaining high accuracy in QR code printer source identification.
(2) A decentralized serial collaboration strategy is introduced, wherein smartphones cyclically transfer and update model weight parameters. The provided approach fully integrates the unique data distribution characteristics of each smartphone, replacing the traditional parallel federated learning strategy that relies on parameter aggregation at a central server. This mechanism significantly enhances privacy protection.
(3) A pre-trained Vision Transformer model trained on a large-scale dataset is utilized as the initial authentication model within the serial federated learning framework. The model parameters are then sequentially transmitted and updated across multiple smartphones to better adapt to the local data on each device. Compared to previous CNN-based models, this approach demonstrates superior robustness under conditions such as blur and noise interference.

### BRIEF DESCRIPTION OF DRAWINGS

Embodiments of the invention are described in more details hereinafter with reference to the drawings, in which:

FIG. 1 shows the principle of the proposed approach according to some embodiments of the present invention;

FIG. 2 shows printer source identification of QR codes using PFormer according to some embodiments of the present invention;

FIG. 3 shows the algorithm applied to the proposed approach according to some embodiments of the present invention;

FIG. 4 illustrates an architecture of a system for QR code printer source identification according to some embodiments of the present invention;

FIG. 5 provides Table I for detailed information on the brands and models of all printers used;

FIG. 6 provides Table II for brands and models of smartphones;

FIG. 7 provides Table III for examples of QR code patches produces by nine printers and five smartphones;

FIG. 8 provides Table IV for comparison with previous centralized training models;

FIG. 9 provides Table V for experiments with different federated learning frameworks;

FIG. 10 provides Table VI for anti-blur experiment using pre-trained models under CWT federated framework;

FIG. 11 shows the relationship between the number of communication rounds and the accuracy of the models using the CWT federated learning algorithm; and

FIG. 12 shows Table VII for pre-training ablation experiment of the proposed method.

### DETAILED DESCRIPTION OF THE INVENTION

In the following description, systems and methods for privacy-preserving printer source identification of QR code labels and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Recent studies have shown that Vision Transformers (ViTs) exhibit strong robustness against interference, domain shifts, and other distortions. The present invention introduces ViTs into the domain of printer source identification for QR code labels. Compared to convolutional neural networks (CNNs), ViTs better capture global relationships between image elements and possess stronger representational capabilities. However, due to the absence of convolutional inductive bias, ViTs require extensive training data to learn local features effectively, increasing their demand for large-scale datasets. To address this challenge, a ViT model pre-trained on the large-scale ImageNet-1K dataset is adopted, and its knowledge is transferred to the task of QR code printer source identification.

In this regard, Federated learning provides a solution by enabling models to be trained using locally distributed data across multiple clients. In one embodiment, each client (e.g., each smartphone in a smartphone group) independently trains a local model using its dataset and shares only model parameters with other participants, without transmitting actual data. This approach enhances data security and privacy, supporting a shift from centralized printer source identification to a privacy-preserving decentralized approach.

To enhance the clarity and comprehensibility of the key features discussed in the present disclosure, an overview of representative printer source identification methods is first provided, covering both traditional feature extraction-based approaches and deep learning-based approaches.

### Related Works

### Related Works—A. Feature Extraction-Based Approaches

Several studies have explored various methods for printer source identification. One of the related works develops a printer source identification system by integrating the printer's intrinsic signature with texture and band features. One of the related works introduces a technique for identifying the source of color laser-printed materials, such as artworks and banknotes, by analyzing noise texture and utilizing a support vector machine (SVM) classifier. One of the related works employs the gray level co-occurrence matrix (GLCM) and discrete wavelet transform to extract features from scanned Chinese characters to determine the source printer.

One of the related works proposes a content-independent printer source identification approach based on synthetic texture analysis, leveraging Fast Fourier Transform (FFT) and GLCM for feature extraction, followed by SVM classification. One of the related works conducts a microscopic-scale statistical analysis of printed patterns, utilizing shape descriptors for feature extraction and employing SVM and random forests for classification. One of the related works introduces an innovative method based on the Gaussian Mixture Model-Universal Background Model (GMM-UBM) and joint factor analysis. This approach focuses on the primary Local Binary Pattern (LBP) within the printer space and extracted secondary features through joint factor analysis.

Despite their effectiveness, these methods rely on manually designed feature extraction and selection processes, which are not only time-consuming but also heavily dependent on expert knowledge. Additionally, the random selection of training and testing samples increases processing complexity, requiring multiple iterations of the entire process, leading to significant resource consumption.

### Related Works—B. Deep Learning-Based Approaches

Deep learning techniques, particularly convolutional neural networks (CNNs), have achieved significant breakthroughs in vision tasks, leading to initial efforts in applying CNNs to printer source identification for documents and images. One of the related works introduces a deep learning approach for laser printer attribute identification, focusing on small block character pattern analysis. This method employs multiple shallow CNNs to capture diverse representations of the same character, which were then fused to enhance feature extraction. However, this approach required specialized data collection equipment, resulting in considerable resource expenditure in terms of time, cost, and materials.

One of the related works develops a color laser printer identification method based on a deep neural network and cascaded learning. This approach leverages adversarial training to refine the network by decomposing halftone colors from synthesized pattern datasets. A decomposition network is trained on refined data, and the learned knowledge is transferred to a printer identification network, achieving high identification accuracy. However, this method is specifically designed for color printers, and its halftone decomposition technique is unsuitable for black-and-white images, such as anti-counterfeiting QR codes.

One of the related works proposes a shallow CNN model for authenticating printer sources using images and documents collected via microscopes and scanners, achieving performance comparable to shallow machine learning methods. One of the related works introduces a CNN-based model called PSINet, specifically designed to identify QR code printer sources from scanner-acquired images. PSINet, which relies on residual modules, demonstrates high accuracy across eight different printers. One of the related works further applies pre-trained CNN models to the task of printer source identification using a limited QR code dataset, with experimental results showing that ResNet18 performed well. Subsequently, a printer source identification model based on residual blocks is designed to handle both grayscale and color QR codes.

The success of the aforementioned studies is largely attributed to the availability of clear, high-quality QR code images captured using specialized scanners, which facilitate effective feature extraction. However, the bulky nature and limited portability of scanners restrict their practical application. In contrast, identifying the printer source of QR codes using smartphones offers a more convenient, fast, and efficient alternative. To enhance QR code printer source identification performance under mobile device acquisition conditions, a residual attention network incorporating bottleneck residual blocks and a squeeze-excitation module is proposed. The squeeze-excitation module enhances focus on features representing printer attributes, reduces interference from irrelevant information, and effectively improves performance with minimal additional model parameters.

In summary, all the aforementioned methods rely on a centralized authentication framework, where QR code data captured by smartphones is uploaded to a central server for processing. However, increasingly stringent privacy protection regulations and growing concerns over data security have presented significant challenges to the traditional centralized training model. Due to the risk of data breaches, users are becoming increasingly reluctant to transmit and share real-time data, rendering centralized data collection, storage, and processing unsustainable. This highlights the urgent need for a privacy-preserving decentralized printer source identification method for QR codes.

### Proposed Approach

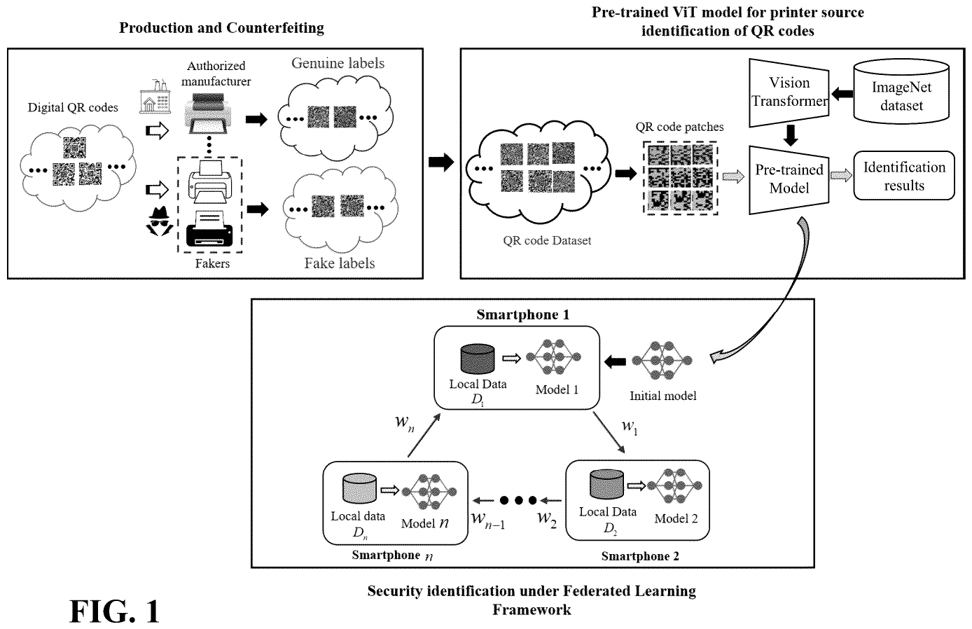

The present invention presents a decentralized serial federated learning framework based on a Pre-trained Vision Transformer (SFed-PFormer) for QR code printer source identification. The principle of this approach according to some embodiments is illustrated in FIG. 1. Briefly, in the proposed SFed-PFormer, the production of genuine QR codes is carried out by authorized manufacturer, and counterfeiting is carried out by multiple unauthorized printers. The printer source identification of QR code dataset is first fine-tuned using Pre-trained Vision Transformer (PFormer) model, and then the PFormer model is deployed in a decentralized serial federated learning framework called Cyclic Weight Transfer (CWT).

Specifically, the method begins by fine-tuning the PFormer to adapt it for printer source identification of QR codes. To maximize the effectiveness of the VIT model, a pre-trained version from the large-scale ImageNet-1K dataset is selected. In one embodiment, the inventive step lies in the application of the PFormer model to printer source identification. Once the model is fine-tuned, it is deployed within a serial federated learning framework. Given that different users capture QR codes under varying conditions, such as lighting variations, hand-held stability, and environmental noise, the present invention introduces a novel serial federated learning algorithm. In this framework, model parameters and weights are cyclically transferred and updated between smartphones, allowing the model to better adapt to the unique data distribution of each smartphone.

### Proposed Approach—A. Printer Source Identification of QR Codes Using PFormer

In smartphone-based QR code printer source identification, image clarity and quality often suffer due to camera jitter, ambient noise, and other distortions. These factors negatively impact identification performance, necessitating the development of a robust and interference-resistant identification model. Vision Transformer (ViT) fundamentally transforms image processing tasks into sequence processing problems, drawing parallels to natural language processing (NLP). By leveraging the Transformer architecture and attention mechanisms, ViT effectively captures global features in images, making it well-suited for tasks requiring strong generalization.

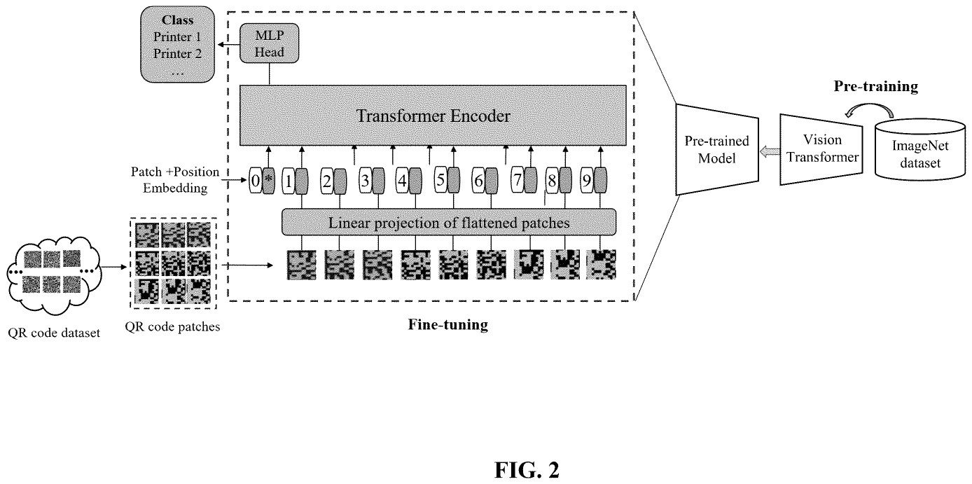

Vision Transformer models pre-trained on large-scale datasets exhibit superior robustness and generalization when transferred to downstream tasks. The present invention introduces the PFormer model for QR code printer source identification, as illustrated in FIG. 2. FIG. 2 shows printer source identification of QR codes using PFormer according to some embodiments of the present invention. The QR codes are first divided into multiple patches, and then sent to the pre-trained Vision Transformer model for fine-tuning to obtain the initial model. In one embodiment, the inventive step lies in the application of the PFormer model to this specific task as discussed.

One of the main challenges in using ViT for QR code printer source identification is its high data demand. Unlike other tasks with abundant training samples, QR code printer source identification typically involves limited datasets. To address this limitation, the present disclosure incorporates a ViT model pre-trained on the ImageNet-1K dataset and fine-tunes it for QR code printer source identification, enabling the model to perform effectively despite constraints on training data availability.

Given an input two-dimensional QR code image X∈ [symbol] , where the dimensions (h, w) denote the QR code image resolution, c represents the number of channels. The image is reshaped into a sequence of flattened two-dimensional patches xₚ∈ [symbol] , while (p, p) defines the size of each patch. The effective sequence length for the transformer becomes n=hw/p². Each patch is flattened into a vector xₚ∈ [symbol] and projected into a high-dimensional embedding space using a trainable linear projection. Formally, for each patch pᵢ, the embedding is computed as follows:

$${z}_{i} = {W}_{p} \cdot Flatten ( {p}_{i} ) + {b}_{p} ; for i = 1 , … , N \qquad ( 1 )$$

where Wₚ∈ [symbol] is the trainable weight matrix and bₚ is the bias. Here, D is the dimensionality of the patch embedding. The resulting sequence of patch embeddings is then Z=[z₁, z₂, . . . . Z_{N}]. Then, ViT introduces learnable positional embeddings to encode the spatial arrangement of QR code patches. The position embedding Et is added to each patch embedding:

$${z}_{i}^{0} = {z}_{i} + {E}_{i} \qquad ( 2 )$$

The above operation ensures that the ViT model is aware of the relative positions of the patches within the QR code image, which is crucial for correctly capturing the spatial structure of the QR code image. Then, the core of the Vision Transformer is the Transformer encoder, it composed a multi-head attention layer, a feed-forward neural network, a shortcut connection and layer normalization.

$$MultiHead ( {Q}^{′} , {K}^{′} , {V}^{′} ) = Concat ( {head}_{1} , … , {head}_{2} ) {W}^{o} \qquad ( 3 )$$

where headᵢ=Attention (Q′, K′, V′). The feed-forward network (FFN) follows the self-attention layers and comprises two linear transformation layers with a nonlinear activation function between them, and can be denoted as follows:

$$FFN ( X ) = {W}_{2} σ ( {W}_{1} X ) \qquad ( 4 )$$

where W₁ and W₂ denote the parameter matrices associated with two linear transformation layers, while σ signifies the nonlinear activation function applied between them. Subsequently, a residual connection is incorporated into each sublayer to enhance the flow of information, thereby improving the overall performance of the model. After the residual connection, the Layer-normalization is performed, and the output Y is as follows:

$$Y = LayerNorm ( X + Attention ( X ) ) \qquad ( 5 )$$

The self-attention layer utilizes X as its input, with the Query (Q), Key (K), and Value (V) matrices all being generated from the same input matrix X.

### Proposed Approach—B. Pre-Trained Vision Transformer-Based Federated Learning

To achieve effective privacy protection while identifying the printer source of QR codes, the PFormer model is deployed within a serial federated learning framework, implementing a Cyclic Weight Transfer (CWT) strategy. This framework enables decentralized model training across multiple smartphones, each collecting QR code data locally. Unlike traditional federated learning algorithms, where a central server aggregates model updates, CWT operates in a cyclic manner. In this approach, each smartphone independently updates the model using its local dataset before passing the updated model to the next smartphone in the cycle. This direct communication between smartphones eliminates reliance on a central server, reducing the communication burden and enhancing data privacy. Such an approach is particularly well-suited for edge computing scenarios, where distributed and privacy-preserving learning is required. The process of CWT can be described as follows:

$${W}_{c}^{t} = LocalUpdate ( {W}_{c - 1}^{t} + {D}_{c} ) \qquad ( 6 )$$

where c represents the set of clients, and

$${W}_{c}^{t}$$

denotes the model weights at client c after training for t iterations,

$${W}_{c - 1}^{t}$$

are the model weights transferred from the previous client in the cycle, Dc is the local dataset of client c, LocalUpdate(⋅) denotes the weight update process using the local data at client c.

By cyclically transferring model weights among smartphones, the provided approach enhances model robustness and generalization while maintaining data privacy. The PFormer model, originally trained on the ImageNet-1K dataset, is fine-tuned for printer source identification task of QR codes using the above federated learning setup.

Each client c fine-tunes the ViT model on its local dataset Dc, which contains QR codes generated by various printers. The objective is to minimize the cross-entropy loss:

$${ℒ}_{c} ( W ) = - \frac{1}{\vert {D}_{c} \vert} {\sum }_{( I , y ) ∈ {D}_{c}} y log ( \hat{y} ) \qquad ( 7 )$$

Where ŷ is the model's predicted probability distribution, and y is the ground truth label for the printer.

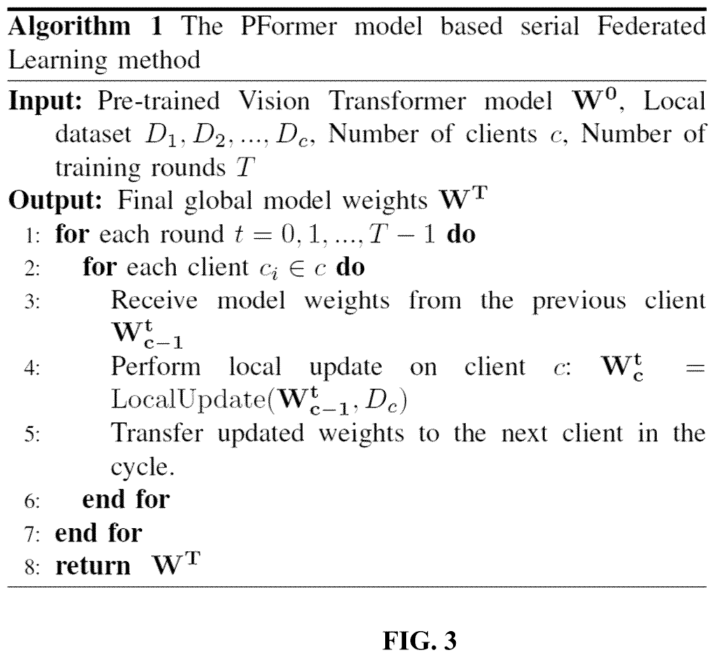

The algorithm performed using these equations is illustrated in FIG. 3.

The above technical content can be implemented in a combination of hardware, software, and firmware configurations, such as being installed on a computer station, a central server or smartphones and enabling collaboration through wired or wireless communication. For example, some general components are distributed across smartphones, and shared components are installed on a central server.

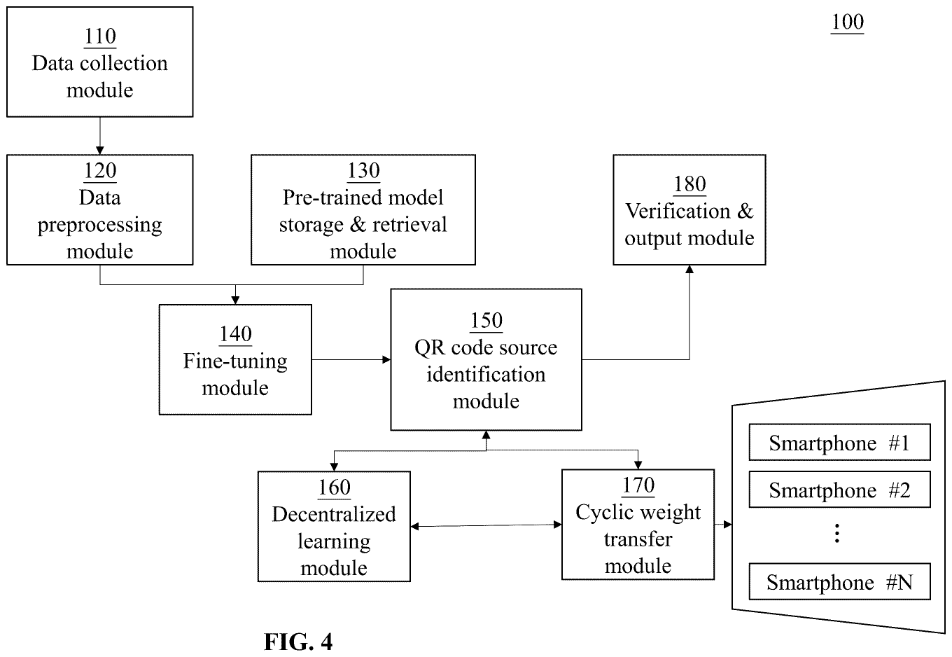

FIG. 4 illustrates an architecture of a system 100 for QR code printer source identification according to some embodiments of the present invention. The system 100 is built on a pre-trained Vision Transformer (ViT) and federated learning, incorporating multiple modules that work together to achieve QR code source identification and maintain data privacy protection and high recognition accuracy.

Specifically, the system 100 includes a data collection module 110, a data preprocessing moule 120, a pre-trained model storage and retrieval module 130, a fine-tuning module 140, a QR code source identification module 150, a decentralized learning module 160, a cyclic weight transfer module 170, and a verification and output module 180.

The data collection module 110 is configured to acquire QR code images from different printers, including both legitimate and counterfeit devices, to construct a QR code dataset. The data preprocessing module 120 communicates with the data collection module 110 and is configured to convert the collected QR code images from the data collection module 110 into patches and applies position embeddings to make them compatible with the input format of the transformer model. In some embodiment, a plurality of data collection modules 110 and the data preprocessing modules 120 are installed across multiple smartphones, respectively.

The pre-trained model storage and retrieval module 130 is configured to store the ViT model pre-trained on the ImageNet-1K dataset and invokes it for identification purposes. The pre-trained model storage and retrieval module 130 manages the storage, retrieval, and loading of the ViT model when required for QR code printer source identification. The fine-tuning module 140 communicates with the data preprocessing module 120 and the pre-trained model storage and retrieval module 130 and is configured to adapt the ViT model to the QR code printer source identification task, optimizing or fine-tuning it for recognizing different printer-specific characteristics and improving classification accuracy. In some embodiment, the single pre-trained model storage and retrieval module 130 and the single fine-tuning module 140 are installed on a central server.

Further elaboration on the collaborative relationship among the data collection module 110, the data preprocessing module 120, the pre-trained model storage and retrieval module 130, and the fine-tuning module 140 is provided below.

The data collection module 110 acquires QR code images from various sources, including genuine labels from authorized printers and fake labels from counterfeiters, constructing a dataset essential for printer source identification. The collected QR code images are then transmitted to the data preprocessing module 120, which converts them into QR code patches and applies position embeddings to structure them for transformer-based analysis. In some embodiment, there are multiple data collection modules 110 and multiple data preprocessing module 120, and thus a plurality of sets of QR code patches are generated. The processed QR code patches (e.g., the sets of QR code patches) are then sent to the pre-trained model storage and retrieval module 130, which retrieves a ViT model pre-trained on the ImageNet dataset.

The fine-tuning module 140 serves as a core intermediary, facilitating direct collaboration with the data preprocessing module 120 and the pre-trained model storage and retrieval module 130 to refine the model for QR code printer source identification. The fine-tuning module 140 receives preprocessed QR code patches (e.g., the sets of QR code patches) from one or more of the data preprocessing modules 120 and retrieves the pre-trained ViT model from the pre-trained model storage and retrieval module 130 to initiate the fine-tuning process.

Within the fine-tuning module 140, the ViT model undergoes task-specific optimization to adapt its parameters for QR code printer source identification. In this regard, the fine-tuning module 140 may include a transformer encoder and a multi-layer perceptron (MLP) head. The transformer encoder of the fine-tuning module 140 is configured to extract high-level feature representations from the QR code patches processed by the data preprocessing module 120. The transformer encoder leverages self-attention mechanisms to capture global contextual relationships within the QR code structure, allowing the model to discern subtle variations introduced by different printers. The transformer encoder enables the system to differentiate between genuine and counterfeit QR codes based on their printer-specific characteristics. Moreover, positional embeddings incorporated during preprocessing further enhance the encoder's ability to maintain spatial awareness of QR code features. The MLP head of the fine-tuning module 140 is integrated to enhance classification performance by mapping the high-dimensional feature representations extracted by the transformer encoder into printer source categories. The MLP architecture consists of fully connected layers that perform nonlinear transformations, facilitating decision boundaries for classification. The MLP head processes the output tokens generated by the transformer encoder and assigns each QR code to a specific printer source based on learned feature patterns. In some embodiments, fine-tuned model parameters are relayed back to the pre-trained model storage and retrieval module 130 for storage and retrieval.

The QR code source identification module 150 communicates with the fine-tuning module 140 and utilizes the transformer's global feature extraction capability to classify QR codes based on their source printer, outputting the corresponding identification results, such as Printer 1, Printer 2, or a verified authentic Printer. To further enhance privacy protection and decentralized learning efficiency, the QR code source identification module 150 interacts closely with the decentralized learning module 160 during the identification process. Instead of relying on a centralized server, the QR code source identification module 150 continuously updates the model parameters through collaborative operations with the decentralized learning module 160. The decentralized learning module 160, built upon federated learning principles, enables each smartphone to locally update the model without uploading raw data to a central server, allowing user data to remain stored on local devices to mitigate privacy risks.

To address model bias caused by data heterogeneity in a decentralized learning environment, the cyclic weight transfer module 170 collaborates with both the QR code source identification module 150 and the decentralized learning module 160. When the QR code source identification module 150 completes a model update on a particular device, the decentralized learning module 160 does not immediately aggregate the updates into a global model. Instead, it transmits the updated model weights (Wi) sequentially to the next device through the cyclic weight transfer module 170.

For example, the cyclic weight transfer module 170 facilitates the progressive transmission of model weights across multiple smartphones (#1 to #N), allowing each device to receive the latest model updates from the previous device rather than aggregating all updates through a central server. When smartphone #1 completes local training, the updated model weight W1 is transmitted to smartphone #2, which further trains the model based on its local data before passing its updated weight W2 to the next smartphone. This process continues until the final device, smartphone #N, completes its update, at which point the final model weight WN is transmitted back to the cyclic weight transfer module 170 for initialization of the next training round.

Ultimately, the trained model, refined through the decentralized learning module 160 and the cyclic weight transfer module 170, is utilized by the QR code source identification module 150 for final classification.

The verification and output module 180 communicates with the QR code source identification module 150 and is configured to determine whether a given QR code originates from an authorized printer and to output the corresponding verification results, ensuring QR code authenticity and counterfeit prevention.

In one embodiment, the printer source identification system 100 is configured to enable smartphones to function as independent edge devices, allowing real-time QR code verification while maintaining privacy protection and minimizing reliance on a central server.

The data collection module 110, the data preprocessing module 120, the QR code source identification module 150, the decentralized learning module 160, the cyclic weight transfer module 170, and the verification and output module 180 can be set up in each of smartphone. The data collection module 110 captures QR code images, which are then processed by the data preprocessing module 120 to extract the QR code region, segment it into patches, and apply position embeddings for further analysis. The QR code source identification module 150 utilizes a fine-tuned vision transformer model to classify the QR code's printer source, and the verification and output module 180 displays the classification results, confirming authenticity or flagging potential fraud. To enhance model performance without compromising privacy, the decentralized learning module 160 performs local model updates using federated learning principles, ensuring that raw QR code data remains stored on the smartphone. The cyclic weight transfer module 170 enables smartphones to sequentially transmit updated model weights to other devices, contributing to a privacy-preserving collaborative learning process.

On the central server, the pre-trained model storage and retrieval module 130 and the fine-tuning module 140 are set up. The pre-trained model storage and retrieval module 130 maintains the vision transformer model, and the fine-tuning module 140 periodically refines it based on aggregated model updates from multiple smartphones. This setup allows the central server to focus on computationally intensive tasks, such as model fine-tuning and storage, and smartphones operate autonomously for real-time QR code authentication.

For example, when a user captures a QR code using a smartphone, the data collection module 110 acquires the QR code image and transmits it to the data preprocessing module 120, which processes the image by extracting the QR code region, segmenting it into patches, and applying position embeddings to prepare it for Transformer-based analysis. The preprocessed QR code data is then sent to the QR code source identification module 150, where a fine-tuned Vision Transformer model analyzes the image to classify the QR code based on printer-specific characteristics, distinguishing between genuine and counterfeit sources. The verification and output module 180 processes the classification results and provides real-time feedback to the user. If the QR code is determined to be authentic, the smartphone displays a confirmation message verifying its legitimacy. Conversely, if the QR code is suspected to be counterfeit, the system generates an alert to notify the user of potential fraud.

The following provides validation of the proposed system to demonstrate its feasibility.

### Experiments

The experiments are conducted to verify the proposed method. The evaluation is performed on a newly created dataset, where all presented methods are tested and analyzed. To demonstrate the effectiveness of the proposed method, a series of comparative experiments are conducted, including comparisons with previous centralized training models, evaluations of different federated learning algorithms, ablation studies, and anti-blur tests. These experiments comprehensively assess the performance, robustness, and adaptability of the proposed approach under various conditions.

### Experiments—A. Dataset Production

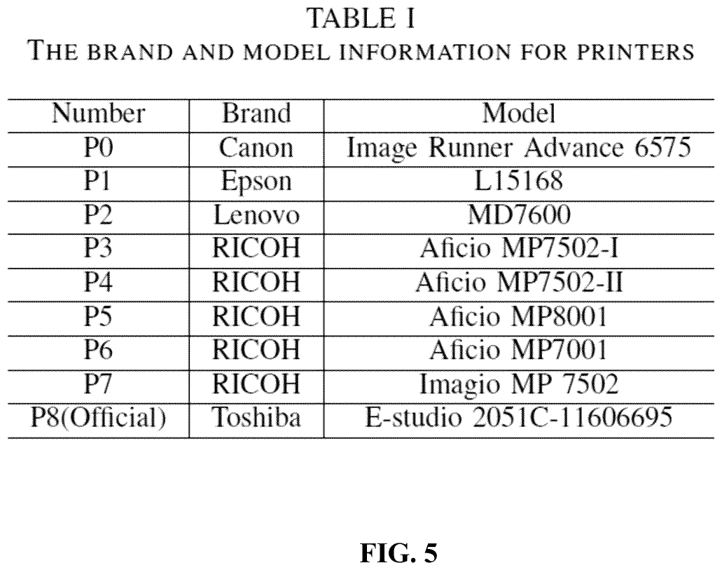

Currently, no publicly accessible dataset exists for studying privacy-preserving printer source identification of QR codes captured across various smartphone models. To address this gap, a custom QR code dataset was developed specifically for printer source identification. Initially, an officially authorized printer is used to generate 48 authentic QR codes with varying contents. Subsequently, eight additional printers of different brands and models are employed to produce counterfeit QR codes, with each printer generating 48 QR codes featuring unique content. Table I of FIG. 5 provides detailed information on the brands and models of all printers used.

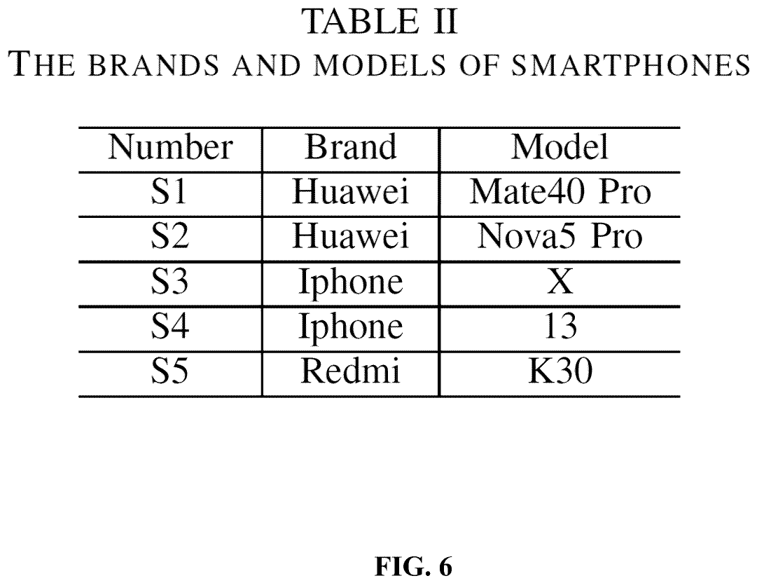

To capture these QR codes, five different smartphones are selected as clients, each capturing QR code images printed by each of the nine printers. As shown in Table II of FIG. 6, this process results in 240 QR code images per printer, leading to a total dataset of 1,920 QR code images, each standardized to a resolution of 512×512 pixels.

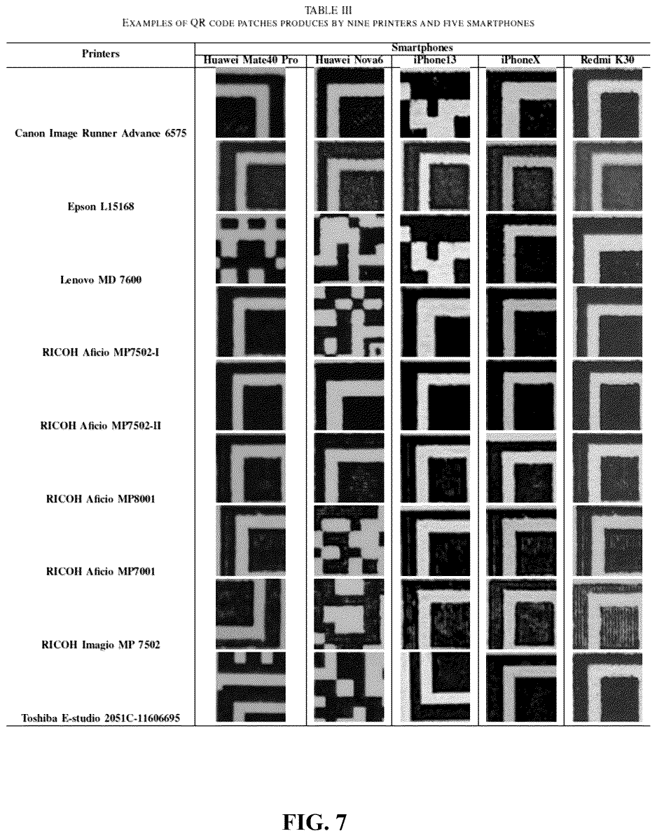

In deep learning-based printer source identification of QR codes, the differences between QR codes printed by different printers can be relatively subtle. To enhance these differences and reduce the interference caused by QR code content, a block-based pre-processing approach is adopted. Each QR code image is divided into 64 smaller patches, with each patch measuring 64×64 pixels. Table III of FIG. 7 presents examples of QR code patches produced by the nine printers and five smartphones.

Each of the five clients in the system has a local training set containing QR code patches from nine different printers, yielding 2,304 patches per printer, leading to 20,736 patches per client and a total of 103,680 patches across all clients. The validation set is similarly structured, containing 1,920 QR code patches per printer, totaling 17,280 validation patches. The test set follows the same distribution as the validation set. In total, the dataset comprises 138,240 QR code patches, forming a comprehensive dataset for evaluating QR code printer source identification models in a privacy-preserving federated learning framework.

### Experiments—B. Implementation Details

The proposed approach utilizes the PyTorch deep learning framework and is trained on an GPU equipped with 12 GB of memory. During training, a batch size of 32 is set for local updates, and Stochastic Gradient Descent (SGD) with an initial learning rate of 0.003 is employed for optimization. The data collection process involves five different smartphones, each acting as a local client, leading to the establishment of five distinct data centers. Each client undergoes one epoch of local training per round, with the overall training process spanning 100 communication rounds.

To maintain comparability across experiments, all pre-trained models are initialized with weights from the ImageNet-1K dataset. Given the emphasis on privacy-preserving identification in smartphone deployment, models with excessive parameter counts and high computational complexity are avoided to improve feasibility in edge environments. As a result, all models used for performance evaluation are constrained to be under 50 MB in size, ensuring efficiency and suitability for smartphone-based applications.

### Experiments—C. Comparison with Previous Centralized Training Models

The part (C) presents a comparison of the proposed method with state-of-the-art models on a self-constructed QR code dataset. Several widely used deep learning algorithms in image forensics were reimplemented, including ResNet18 and EfficientNet-b5. Additionally, the proposed approach was compared with CNN-based models specialized in printer source identification, such as PSDI, PSINet, and SE-BRB-Net. The PSDI model, based on AlexNet modifications, replaces the 11×11 convolutional layer with a 5×5 convolutional layer, reducing the loss of printer fingerprint information and improving identification accuracy for printed documents under scanner and microscope acquisition conditions. The PSINet model, utilizing bottleneck residual blocks, is designed for QR code printer source identification in scanned images. In contrast, SE-BRB-Net combines bottleneck residual blocks with a squeeze-excitation attention module, making it highly effective for QR code printer source identification using smartphone-acquired images.

Although these methods demonstrate competitive identification accuracy when using centralized training, they suffer from a significant limitation-they do not safeguard the privacy of training data in QR code printer source identification tasks. Previous research in vision tasks has shown that fine-tuning models pre-trained on large datasets, such as ImageNet-1K, typically outperforms training from scratch and achieves faster convergence. Therefore, the present disclosure adopts a pre-training and fine-tuning strategy, where ResNet18, EfficientNet-b5, ViT(tiny), and ViT(small), when fine-tuned on QR code printer source identification, are referred to as PResNet, PEfficientNet, PFormer(T), and PFormer(S), respectively, under the traditional centralized authentication mode.

In contrast, the proposed approach employs a decentralized training framework, where personal data remains on local clients instead of being collected in a central repository. The proposed approach differentiates itself from previous centralized training methods that overlook privacy concerns. To evaluate its performance under this new framework, ResNet18, EfficientNet-b5, ViT(tiny), and ViT(small), fine-tuned under the serial federated learning framework, are referred to as SFed-PResNet, SFed-PEfficientNet, SFed-PFormer(T), and SFed-PFormer(S), respectively.

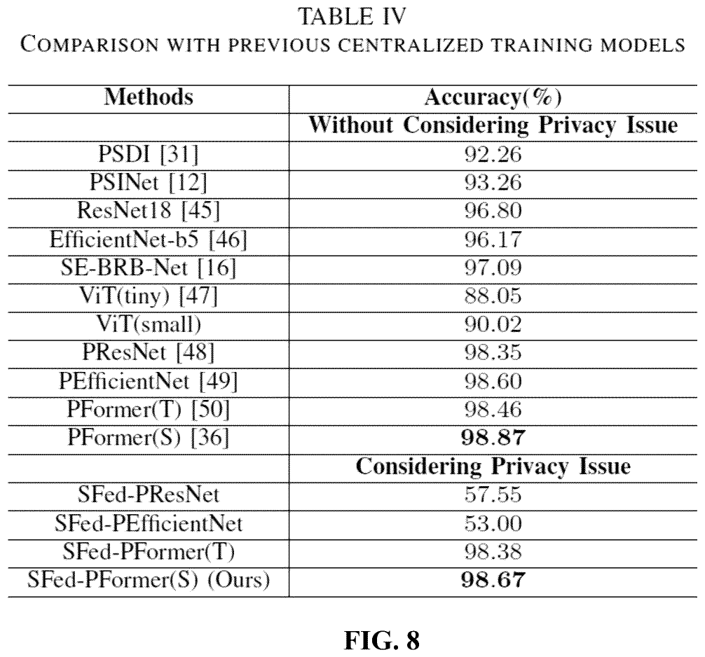

From Table IV of FIG. 8, the best-performing model for printer source identification without considering privacy is SE-BRB-Net, which excels due to its squeeze-excitation attention mechanism that enhances fingerprint feature extraction from printed QR codes, particularly in smartphone acquisition scenarios. Following SE-BRB-Net, ResNet18 and EfficientNet-b5 achieve state-of-the-art performance in general vision tasks, showcasing their versatility in printer source identification. The PSDI and PSINet models, while specifically designed for printer source identification in scanned documents and QR codes, experience performance degradation when applied to smartphone-acquired images due to image quality variations. Lastly, ViT(tiny) and ViT(small) struggle when trained from scratch due to limited data availability. However, when pre-trained models PResNet, PEfficientNet, PFormer(T), and PFormer(S) are fine-tuned for QR code printer source identification, they significantly outperform models trained from scratch. The PFormer(T) and PFormer(S) models achieve the highest accuracy, with PFormer(S) reaching 98.87% accuracy.

When privacy concerns are taken into account, serial federated learning with CWT is introduced. Due to heterogeneous data distributions across multiple smartphones, the identification accuracy of pre-trained models (SFed-PResNet, SFed-PEfficientNet, SFed-PFormer(T), and SFed-PFormer(S)) decreases to varying degrees compared to their centralized counterparts. The respective accuracy scores are 57.77%, 53.00%, 98.38%, and 98.67%. SFed-PResNet and SFed-PEfficientNet experience significant performance drops of 40.80% and 45.60%, respectively, compared to PResNet and PEfficientNet. However, SFed-PFormer(T) and SFed-PFormer(S) exhibit only minor accuracy reductions of 0.08% and 0.20%, respectively, compared to PFormer(T) and PFormer(S).

These results indicate that under federated learning with privacy-preserving constraints, ViT-based models exhibit much better robustness than CNN-based models when dealing with heterogeneous smartphone-acquired data, making them well-suited for privacy-sensitive QR code printer source identification tasks.

### Experiments—D. Comparison of Different Federated Learning Methods

The part (D) explores two prominent federated learning algorithms, namely parallel FedAVG and serial CWT, for privacy protection. In this context, both algorithms are evaluated by implementing six widely used deep learning models: ResNet18, EfficientNet-b5, Swin(tiny), Swin(small), ViT(tiny) and ViT(small) within each federated learning framework. Among them, Swin(tiny) and Swin(small) are different versions of Swin Transformer. Swin Transformer is a novel vision transformer architecture designed to address computational efficiency and scalability challenges in image processing tasks. Unlike conventional transformers that operate on fixed-size global attention mechanisms, Swin Transformer introduces a hierarchical structure where the input image is processed at multiple scales with shifted windows. This window-based self-attention mechanism, combined with the shifting strategy, reduces computational complexity while maintaining high performance on various vision benchmarks. Swin Transformer has demonstrated state-of-the-art results in several vision tasks by leveraging its efficient design and ability to capture both local and global contextual information. The main difference between Swin(tiny) and Swin(small) lies in the model size and computational complexity. Swin(tiny) uses fewer Transformer layers and smaller hidden dimensions, making it more lightweight and suitable for applications with lower resource demands. On the other hand, Swin(small) increases the number of layers and hidden dimensions, providing greater capacity to handle more complex tasks while still maintaining relatively low computational cost compared to larger versions. Both models leverage the hierarchical structure and shifted window attention mechanism, but Swin(small) typically offers better performance at the cost of increased computational requirements.

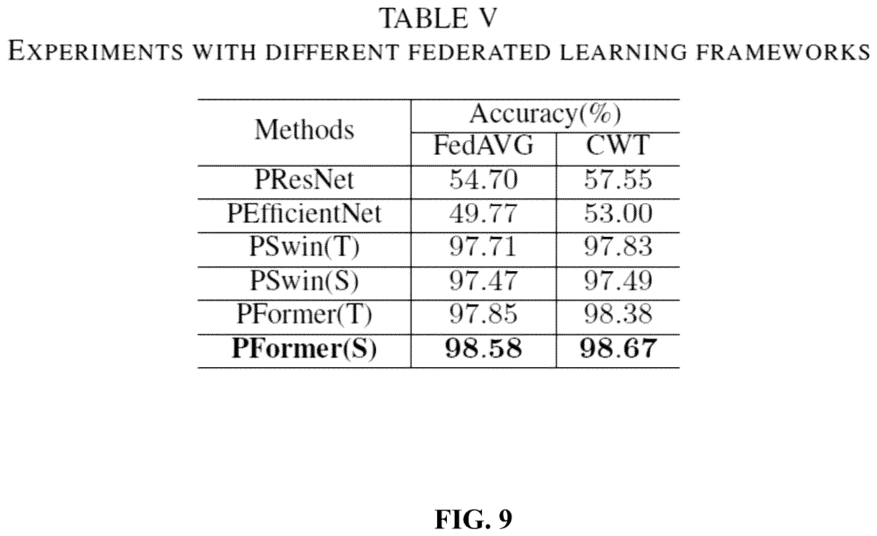

For each model, the training approach of finetuning pre-trained models is applied. For convenience, the above models are abbreviated using the fine-tuning strategy of pre-trained models as PResNet, PEfficientNet, PSwin(T), PSwin(S), PFormer(T) and PFormer(S), respectively. Table V of FIG. 9 shows the comparison results.
(1) Under the two federated learning frameworks of FedAVG and CWT, the accuracy of the PResNet model is 54.70% and 57.55% respectively; the accuracy of the PEfficientNet model is 49.77% and 53.00% respectively; the accuracy of the PSwin(T) model is 97.71% and 97.83% respectively; the accuracy of the PSwin(S) model is 97.47% and 97.49% respectively; the accuracy of the PFormer(T) model is 97.85% and 98.38% respectively; the accuracy of the PFormer(S) model is 98.58% and 98.67% respectively.
(2) The best identification performance is the PFormer(S) model, then comes the PFormer(T) model, followed by the PSwin(T) model, and then the PSwin(S) model. The PResNet and PEfficientNet models perform poorly, among which PEfficientNet performs the worst. The printer source identification task involves globally consistent features (e.g., printer's texture distribution, ink spot noise, subtle artifacts, etc.), Vision Transformer divides the QR code block into fixed-size patches and regards each block as a “word” in the sequence, so that the model can better model these globally consistent features through the self-attention mechanism without relying on a fixed receptive field; whereas Swin Transformer is hierarchically structured that uses a sliding window for local attention calculation, which is then extended to the global layer by layer. This local window mechanism limits the model from capturing globally consistent features of the printer source; and the receptive fields of EfficientNet-b5 and ResNet18 are limited by convolution kernels that are confined to a fixed receptive field, which makes it difficult to adequately capture the globally consistent features of the printer source. The above results show that among these models, the PFormer(S) model has the best robustness and generalization in the privacy-preserving QR code printer source identification task, and can adapt to the collection environment of different smartphones.
(3) The performance of the used six deep learning models in the serial federated learning framework CWT is better than that of the parallel federated learning framework FedAVG. In QR code printer source identification, faced with the differences in fingerprint features of different printers and the differences in device attributes and environments captured by different smartphones, CWT is able to enhance the adaptability of the model to the distribution of the features of each client by periodically transferring the model weights between each smartphone terminal and improving the generalization ability of the pre-trained model. FedAVG, on the other hand, trains the model locally by each client and then averages the weights and updates them to the global model, which ignores the diversity of data distributions of different clients during model aggregation by simple weighted averaging.

### Experiments—E. Anti-Blur Experiments

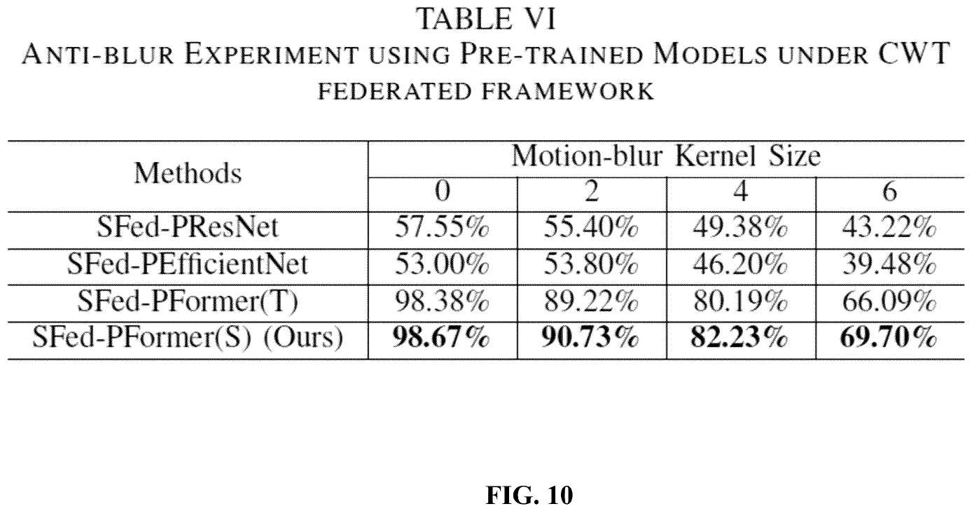

In practical applications, relative motion between the smartphone and the QR code label during handheld capture often causes image blurring, potentially degrading the performance of the printer source identification method. To address this, evaluating the proposed method's robustness against motion induced blurring is essential. Using the OpenCV computer vision library, varying levels of motion blur are batch-applied to all QR code blocks in the test set. The motion blur kernel lengths are set incrementally to 0, 2, 4, and 6, with a fixed blur angle of 45 degrees. A kernel length of 0 represents a sharp, unblurred anti-counterfeiting QR code image, which serves as the reference. Experiments in the preceding sections demonstrate that pre-trained models outperform models trained from scratch in printer source identification of QR code labels. Therefore, pre-trained models are employed, specifically ResNet18, EfficientNet-b5, ViT(S) and ViT (T), with the serial CWT framework used. The experiment results are shown in Table VI of FIG. 10.

As can be seen from Table VI, as the degree of blur increases, the four pre-trained models show a significant decrease in identification accuracy under the serial federated learning framework CWT. Compared with the series of CNN models (SFed-PResNet and SFed-PEfficientNet), the SFed-PFormer series models show obvious anti-blur performance. Regardless of the length of the blur kernel being 2, 4, or 6, the anti-blur performance of SFed-PFormer(S) is always the best. First, the advantage of SFed-PFormer(S) over SFed-PFormer(T) mainly comes from its larger network size and deeper hierarchical structure. Larger models can capture more complex image features, especially when processing blurred images, and can better extract effective information from local to global, thereby improving robustness to blur interference. Secondly, compared to SFed-PResNet and SFed-PEfficientNet, SFed-PFormer can effectively model long-distance dependencies in images through the self-attention mechanism when processing visual tasks, which enables it to more accurately understand and classify image content when facing different degrees of blur. Although SFed-PResNet and SFed-PEfficientNet have strong convolutional feature extraction capabilities, their feature extraction capabilities are limited when processing highly blurred or high-contrast images, and they cannot integrate global information as flexibly as SFed-PFormer, so they are slightly inferior in anti-blurring capabilities. In general, the larger scale and global modeling capabilities of SFed-PFormer(S) enable it to perform better than other models under blurry conditions.

### Experiments−F. Ablation Experiments

In the part (F), effectiveness of the proposed method is validated through ablation experiments.
1) Impact of the number of communication rounds on the performance of proposed approach: This part focuses on the impact of the number of communication rounds on model performance. The setting of the number of communication rounds in federated learning is crucial in the task of QR code printer source identification considering privacy protection, where the fast convergence of the model minimizes the communication requirements and effectively reduces the training time. In the present disclosure, the number of communication rounds is set to 100. After each round of training, the model accuracy of that round is tested and the results are saved. After the overall training process is completed, the convergence speed and identification accuracy of each model are plotted as curves for comparison. The experiment is conducted under the serial federated learning algorithm CWT, four models are considered: ResNet18, EfficientNet-b5, ViT(tiny) and ViT(small). The strategies of fine-tuning the pre-trained model and training from scratch are adopted respectively. For convenience, the models that employ the training-from-scratch strategy are abbreviated as SFed-ResNet, SFed-EfficientNet, SFed-Former(T) and SFed-Former(S); the models that employ the fine-tuning strategy for the pre-trained models are abbreviated as SFed-PResNet, SFed-PEfficientNet, SFed-PFormer(T) and SFed-PFormer(S).

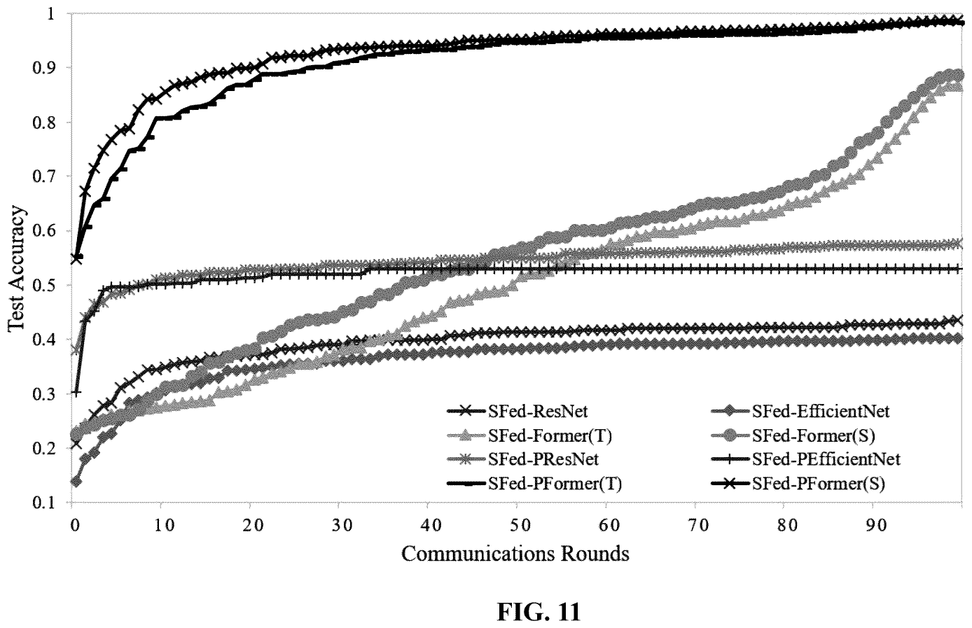

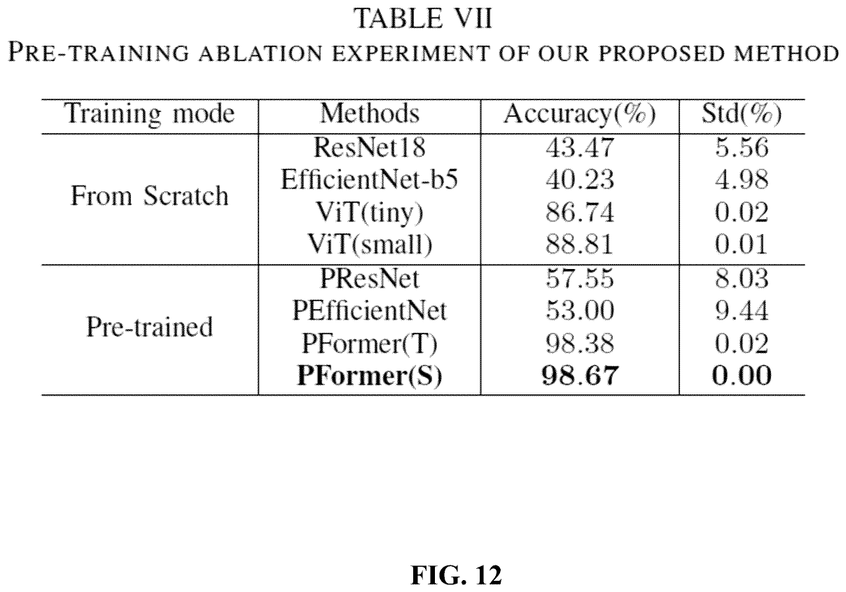

FIG. 11 shows the relationship between the number of communication rounds and the accuracy of the models using the CWT federated learning algorithm, and the following conclusions can be drawn: First, the Vision Transformer class of models (SFed-Former(T), SFed-Former(S), SFed-PFormer(T), SFed-PFormer(S)) exhibits higher identification accuracy than the CNN class of models (SFed-ResNet, SFed-EfficientNet, SFed-PResNet, SFed-PEfficientNet), regardless of whether the pre-trained models are used for fine-tuning or the training from-scratch strategy is used, which illustrates the advantage of the Vision Transformer model in the task of QR code printer source identification. Then, in terms of the convergence speed of the models, fine-tuning using the pre-trained models (SFed-PResNet, SFed-PEfficientNet, SFed-PFormer(T), SFed-PFormer(S)) can converge faster than the training-from-scratch approach (SFed-ResNet, SFed-EfficientNet, SFed-Former(T), SFed-Former(S)), and the identification accuracy of the former is also higher. Finally, the SFed-PFormer(S) model still performs best in terms of identification performance and convergence, validating its advantages.
2) The impact of pre-training method on the performance of proposed approach: This part focuses on verifying the advantages of fine-tuning pre-trained models through ablation experiments using four models, ResNet18, EfficientNetb5, ViT(tiny), ViT(small), with two strategies: training from scratch and fine-tuning the pre-trained models, respectively. As can be seen from Table VII of FIG. 12, when training from scratch is used, the accuracy of the four models ResNet18, EfficientNet-5, ViT(tiny) and ViT(small) is 43.47%, 40.23%, 86.74% and 88.81%, respectively; and the accuracy of the PResNet, PEfficientNet, PFormer(T), and PFormer(S) models is 57.55%, 53.00%, 98.38%, 98.67%, respectively. The results show that the models pre-trained on the large-scale ImageNet-1k dataset have learned rich general visual features, including low-level features (edges, textures) and high-level features (shapes, structures), which are still useful for subtle patterns (differences in detailed textures representing printer attributes) in the QR code printer source identification tasks, and can quickly adapt to specific tasks by adjusting only a small number of parameters during fine-tuning. Whereas training from scratch strategy requires a large amount of data to learn efficient and robust features, in the task of identifying the printer source of QR codes, the data is relatively limited, and the randomly initialized weights have no prior knowledge, which will increase the gradient oscillation in the early stage of training, resulting in unsatisfactory optimization and affecting the identification performance.

In conclusion, smartphone-based printer source identification of QR code labels presents substantial application potential, particularly in privacy-sensitive environments. Traditional deep learning-based models primarily rely on centralized training approaches, which pose privacy leakage risks due to the requirement of transmitting user data to a central server. Local verification directly on smartphones provides an effective solution, allowing sensitive data to remain on the user's device. However, maintaining a balance between data privacy and high identification accuracy remains a significant challenge.

To address this issue, a serial federated learning framework leveraging parameter fine-tuned Vision Transformer models is introduced for QR code printer source identification. The framework utilizes a Vision Transformer model pre-trained on the ImageNet-1K dataset as the initial model, which undergoes refinement through a cyclic weight transfer mechanism, enabling collaborative model training across multiple users. Instead of transmitting raw QR code data, only updated model parameters are shared between smartphones, allowing all QR code data to remain stored locally on user devices. A dedicated QR code dataset, consisting of QR codes printed by nine different printers and captured using five different smartphones, supports evaluation of the approach. Experimental results demonstrate that the proposed method achieves high-accuracy identification performance while preserving data privacy, making it a robust and scalable solution for decentralized QR code authentication.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for printer source identification through classifying QR codes, comprising:
at least one data collection module configured to acquire QR code images from different printers which comprise both legitimate and counterfeit devices to construct a QR code dataset;
at least one data preprocessing module communicating with the data collection module and configured to extract QR code regions from the QR code images of the QR code dataset, convert the extracted QR code regions into fixed-size patches, and apply position embeddings to format the patches for transformer-based analysis;
a pre-trained model storage and retrieval module configured to store a vision transformer(ViT) model pre-trained on a large-scale dataset and to retrieve the pre-trained ViT model when required for QR code printer source identification;
a fine-tuning module communicating with the data preprocessing module and the pre-trained model storage and retrieval module and configured to adapt the pre-trained ViT model to the QR code printer source identification by optimizing the pre-trained ViT model for printer-specific feature extraction and classification;
a QR code source identification module configured to classify QR codes based on their source printers by utilizing the fine-tuned ViT model and to generate corresponding classification results;
a decentralized learning module configured to facilitate local updates of the ViT model on smartphones performing the QR code printer source identification, wherein only model parameters are transmitted to prevent raw data transmission to a central server;
a cyclic weight transfer module configured to sequentially transmit updated model weights of the ViT model across the smartphones, allowing each of the smartphones to preserve user privacy and avoid centralized raw data aggregation; and
a verification and output module communicating with the QR code source identification module and configured to determine whether one or more given QR codes originate from an authorized printer and to output one or more verification results indicating authenticity or counterfeit status.

2. The system according to claim 1, wherein the pre-trained model storage and retrieval module is further configured to maintain the ViT model that is pre-trained on an ImageNet-1K dataset and periodically updated based on aggregated model refinements.

3. The system according to claim 1, wherein the fine-tuning module further comprises a transformer encoder configured to extract high-level feature representations from the patches.

4. The system according to claim 3, wherein the fine-tuning module further comprises a multi-layer perceptron (MLP) head configured to map extracted features into printer source classifications.

5. The system according to claim 1, wherein the QR code source identification module is configured to utilize a self-attention mechanism within the ViT model to capture global contextual relationships within QR code structures, allowing for differentiation between genuine and counterfeit sources.

6. The system according to claim 1, wherein the decentralized learning module employs a federated learning framework to enable the smartphones to update the model parameters locally.

7. The system according to claim 1, wherein the cyclic weight transfer module facilitates sequential weight transmission among the smartphones, allowing each of the smartphones to receive the updated model parameters from its predecessor.

8. The system according to claim 1, wherein a plurality of the data collection modules and a plurality of the data preprocessing modules are installed across the smartphones, respectively, enabling edge-based real-time QR code capture and analysis.

9. The system according to claim 8, wherein the QR code source identification module and the verification and output module are installed on each of the smartphones.

10. The system according to claim 9, wherein the verification and output module generates a confirmation message on the smartphone if the QR code is verified as authentic and an alert notification if the QR code is classified as counterfeit.

11. A method for printer source identification through classifying QR codes, comprising:
acquiring, by at least one data collection module, QR code images from different printers which comprise both legitimate and counterfeit devices to construct a QR code dataset;
extracting, by at least one data preprocessing module, QR code regions from the QR code images of the QR code dataset;
converting, by the data preprocessing module, the extracted QR code regions into fixed-size patches;
applying, by the data preprocessing module, position embeddings to format the patches for transformer-based analysis;
storing, by a pre-trained model storage and retrieval module, a vision transformer(ViT) model pre-trained on a large-scale dataset;
retrieving, by the pre-trained model storage and retrieval module, the pre-trained ViT model when required for QR code printer source identification;
adapting, by a fine-tuning module, the pre-trained ViT model to the QR code printer source identification by optimizing the pre-trained ViT model for printer-specific feature extraction and classification;
classifying QR codes, by QR code source identification module, based on their source printers by utilizing the fine-tuned ViT model and thus generating corresponding classification results;
facilitating, by a decentralized learning module, local updates of the VIT model on smartphones performing the QR code printer source identification, wherein only model parameters are transmitted to prevent raw data transmission to a central server;
sequentially transmitting, by a cyclic weight transfer module, updated model weights of the ViT model across the smartphones, thereby allowing each of the smartphones to preserve user privacy and avoid centralized raw data aggregation; and
determining, by a verification and output module, whether one or more given QR codes originate from an authorized printer and thus outputting one or more verification results for indicating authenticity or counterfeit status.

12. The method according to claim 11, further comprising:
maintaining, by the pre-trained model storage and retrieval module, the VIT model that is pre-trained on an ImageNet-1K dataset and periodically updated based on aggregated model refinements.

13. The method according to claim 11, further comprising:
extracting, by a transformer encoder of the fine-tuning module, high-level feature representations from the patches.

14. The method according to claim 13, further comprising:
mapping, by a multi-layer perceptron (MLP) head of the fine-tuning module, extracted features into printer source classifications.

15. The method according to claim 11, further comprising:
utilizing, by the QR code source identification module, a self-attention mechanism within the ViT model to capture global contextual relationships within QR code structures, thereby allowing for differentiation between genuine and counterfeit sources.

16. The method according to claim 11, wherein the decentralized learning module employs a federated learning framework to enable the smartphones to update the model parameters locally.

17. The method according to claim 11, wherein the cyclic weight transfer module facilitates sequential weight transmission among the smartphones, allowing each of the smartphones to receive the updated model parameters from its predecessor.

18. The method according to claim 11, wherein a plurality of the data collection modules and a plurality of the data preprocessing modules are installed across the smartphones, respectively, enabling edge-based real-time QR code capture and analysis.

19. The method according to claim 18, wherein the QR code source identification module and the verification and output module are installed on each of the smartphones.

20. The method according to claim 19, further comprising:
generating, by the verification and output module, a confirmation message on the smartphone if the QR code is verified as authentic and an alert notification if the QR code is classified as counterfeit.
